(19) United States
(12) Patent Application Publication
(10) Pub. No.: US 2025/0382030 A1
(43) Pub. Date: Dec. 18, 2025

(54) FIXING STRUCTURE FOR STEERING BRACKET AND BODY BRACKET OF TRANSPORTATION TOOL

(71) Applicant: ZHEJIANG LINIX MOTOR CO., LTD., DONGYANG, Zhejiang Province (CN)

(72) Inventors: HAIJUN WANG, DONGYANG, ZHEJIANG PROVINCE (CN); YANPIN LOU, DONGYANG, ZHEJIANG PROVINCE (CN); XIAOLIN WANG, DONGYANG, ZHEJIANG PROVINCE (CN); FANGJIAO LU, DONGYANG, ZHEJIANG PROVINCE (CN); LIJUAN WANG, DONGYANG, ZHEJIANG PROVINCE (CN)

(21) Appl. No.: 18/684,165

(22) PCT Filed: Aug. 2, 2022
(86) PCT No.: PCT/CN2022/109568

§ 371 Date: Feb. 10, 2025

(30) Foreign Application Priority Data
Dec. 31, 2021 (CN) 202111676662.7

(51) Int. Cl. B62K 21/18; B62K 3/00; B62K 15/00

(52) U.S. Cl. CPC B62K 21/18; B62K 3/002; B62K 15/006

(57) ABSTRACT

The present invention relates to a fixing structure for a steering bracket and a body bracket of a transportation tool. A fixing structure for a steering bracket and a body bracket of a transportation tool is provided. The steering bracket comprises an operation portion used for fixing a handlebar and a connecting portion used for fixing a front wheel; the operation portion and the connecting portion are rotationally fixed; a rotating axis is arranged in the left-right direction, and a detachable fixing structure is arranged between the connecting portion and the body bracket; the detachable fixing structure comprises a fixing sleeve and fixing column capable of extending into the fixing sleeve; a first positioning groove is formed on the inner wall of the fixing sleeve and fits with a positioning member; and, when the operation portion rotates, the operation portion drives a movable member to move, so that the position limitation of the positioning member is canceled out. The present invention can realize the quick assembling and disassembling of the steering bracket and the body bracket, and is very convenient to use. Moreover, the structure of the present invention does not affect the normal folding and use of the transportation tool, and the structure is compact.

### TECHNICAL FIELD OF THE INVENTION

The present invention relates to a fixing structure for a steering bracket and a body bracket of a transportation tool.

### BACKGROUND OF THE INVENTION

Transportation tools such as mobility scooters and kick scooters include front wheels and rear wheels, wherein the front wheels are fixed at the lower end of the steering bracket, and the rear wheels are fixed at the rear lower end of the body bracket. To facilitate steering, the steering bracket and the body bracket are rotationally fixed; and, to facilitate storage and transportation, the steering bracket is foldable, such as the scooter mentioned in Chinese Patent Publication CN103979046B. The assembly and disassembly of this scooter are very troublesome, and it is impossible to mount the steering bracket and the front wheels as a whole first and then mount the steering bracket and the body bracket. If such transportation tools are front-wheel driven, it will be more troublesome to assemble or disassemble the steering bracket and the body bracket.

### SUMMARY OF THE INVENTION

The object of the present invention is to provide a fixing structure for a steering bracket and a body bracket of a transportation tool, which is easy to assemble and disassemble.

To achieve the above object, the present invention employs the following technical solutions. A fixing structure for a steering bracket and a body bracket of a transportation tool is provided, wherein the steering bracket includes an operation portion used for fixing a handlebar and a connecting portion used for fixing a front wheel; the operation portion and the connecting portion are rotationally fixed, and a rotating axis is arranged in the left-right direction; a detachable fixing structure is arranged between the connecting portion and the body bracket; the detachable fixing structure includes a fixing sleeve and a fixing column capable of extending into the fixing sleeve; the steering bracket can rotate about the axis of the fixing column; one of the fixing sleeve and the fixing column is fixed to the steering bracket, while the other one of the fixing sleeve and the fixing column is fixed to the steering bracket; a first positioning groove is formed on the inner wall of the fixing sleeve and fits with a positioning member; a second positioning groove is formed on the outer wall of the fixing column; the fixing sleeve is movably connected to a movable member; the movable member has a first limiting surface used for coming into contact with the outer end of the positioning member so that the inner end of the positioning member can extend into an inner cavity of the fixing sleeve or into the second positioning groove; the movable member is linked with the operation portion; and, when the operation portion rotates, the operation portion drives the movable member to move, so that first limiting surface moves away from the positioning member and the position limitation of the positioning member is canceled out.

When it is necessary to assemble the steering bracket and the body bracket, the fixing column is inserted into the fixing sleeve, and the positions of the body bracket and the movable member are maintained. When it is necessary to disassemble the steering bracket and the body bracket, the operation portion of the steering bracket is rotated, so that the operation portion drives the movable member to move, so as to separate the first limiting surface from the positioning member. At this time, the limitation of the positioning member is released, and the locking between the fixing column and the fixing sleeve is released. Thus, the steering bracket or the body bracket can be moved directly, and the steering bracket and the body bracket are disassembled.

The movable member may be locked in multiple ways. For example, a compression spring is provided on the movable member side, or the movable member is fixed to the fixing sleeve or other parts through a fastener. The positioning member may be pin-shaped, or may be spherical.

It is possible to mount all parts on the steering bracket and then mount the steering bracket and the body bracket. The processes of assembling all parts on the steering bracket may be completed together. It is unnecessary to connect the driving wheels on the steering bracket and the control portion after the steering bracket and the body bracket are mounted, and it is unnecessary to rotationally fix the front wheels and the body bracket and then connect the front wheels and the steering bracket. The present invention can realize the quick assembling and disassembling of the steering bracket and the body bracket, and is very convenient to use.

Preferably, the movable member is sleeved outside the fixing sleeve, and the first positioning groove runs through the inner and outer sides of the fixing sleeve.

With this arrangement, it is convenient to machine the first positioning groove, and the positioning member can be made larger and longer, thereby ensuring the connection strength between the steering bracket and the body bracket. Moreover, the movable member and the fixing sleeve can be sleeved with each other to form a guide structure, so that the movement trajectory of the movable member during its movement is a straight line.

Preferably, the operation portion includes a vertical extension portion and connecting plates located at the lower end of the vertical extension portion; middle portions of the connecting plates are rotationally fixed to the connecting portion; and, when the upper end of the operation portion turns forward, the rear portions of the connecting plates move upward and push the movable member to move. This arrangement is used for realizing the linkage between the operation portion of the steering bracket and the movable member.

Preferably, the connecting plates are arranged on the left and right sides of the lower end of the vertical extension portion; the fixing sleeve and the movable member are relatively located between the two connecting plates; the movable member has linkage bumps extending to the outer side; and, when upper end of the operation portions turns forward, the rear portions of the connecting portions move upward and come into contact with the linkage bumps.

By providing the connecting plates on the left and right sides, the structural strength of the steering bracket can be improved. Moreover, structures used for improving the movable member can be arranged between the connecting plates on both sides and the movable member, so that the movement of the movable member is more stable. A space for evading the fixing sleeve and the movable member is formed between the two connecting plates, so that it is convenient to fold the steering bracket of the transportation tool of the present invention.

Preferably, each of the connecting plates comprises a first contact surface used for pushing the linkage bumps to move and a second contact surface capable of coming into contact with the first contact surface; the second contact surface gradually extends upward or downward from front to back and is connected to the first contact surface; and, the first contact surface and the second contact surface form an obtuse angle.

If the movable member is deviated, during the rotation of the connecting plates, since the second contact surfaces gradually extend upward or downward from front to back, the second contact surfaces will first come into contact with the linkage bumps on the movable member. With the continuous rotation of the connecting plates, the linkage bumps of the movable member will move long the second contact surfaces and drive the movable member to gradually restore, until the linkage bumps are supported at the first contact surfaces or at the obtuse angle between the first contact surfaces and the second contact surface and until the movable member is restored. There may be two linkage bumps, and the two linkage bumps are oppositely arranged on left and right sides. It is also possible to provide a plurality of linkage bumps, and the plurality of linkage bumps are evenly distributed on the movable member. When the movable member ascends to release the position limitation of the positioning member, the second contact surfaces extend downward from front to back and are connected to the first contact surfaces; and, when the movable descends to release the position limitation of the positioning member, the second contact surfaces extent upward from front to back and are connected to the first contact surfaces.

Preferably, a fixing block is arranged on the front side of the connecting portion; the junction of the connecting plates and the connecting portion deviates from the front end of the fixing block; a locking mechanism used for maintaining the position of the operation portion is arranged between the fixing block and the connecting plates; and, the locking mechanism includes positioning holes formed on the fixing block and the connecting plates and a locking pin inserted into the positioning holes. The locking pin may be fitted in the positioning hole of the fixing block and the positioning holes of the connecting plates in various existing ways.

Preferably, the locking pin is slidingly fitted in a sliding sleeve; the sliding sleeve is fixed to the operation portion; a second spring used for allowing the end of the locking pin to extend into the positioning holes is arranged in the sliding sleeve; the locking pin is fixed to one end of a pull rope, while the other ends of the pull rope passes through the sliding sleeve and extends into the vertical extension portion to be linked and connected to an operation handle; an accommodating cavity which extends in its own length direction and is used for accommodating the pull rope is formed in the vertical extension portion; a guide groove communicated with the accommodating cavity is formed at the upper end of the vertical extension portion; the outer end of the operation handle extends to the outer side of the vertical extension portion; a limiting bump used for avoiding excessive downward movement of the pull rope is arranged inside or outside the vertical extension portion; the operation handle is fixed and linked to a support bump; and, the limiting bump is always located on the lower side of the support bump.

By pulling the pull rope, the locking pin is pulled to release the locking between the operation portion and the fixing plate, so that the operation portion of the steering bracket can turn forward or backward. By providing the operation handle, it is convenient to pull the pull rope. By providing the support bump, the excessive downward movement of the pull rope is avoided, and the tightness of the pull rope is ensured.

Preferably, a limiting portion extending to the outer circumferential side is arranged at the end of the fixing sleeve where the opening for allowing the fixing column to extend therein is formed; a first spring is arranged outside the fixing sleeve; the first spring is restricted between the limiting portion and the movable member, the movable member is restricted on one side of the limiting portion; and, the movable member has a tendency to move in its own axial direction under the action of the first spring and pushes the first limiting surface to come into contact with the outer end of the positioning member.

The first spring is provided to ensure the effective contact between the first limiting surface of the fixing sleeve and the positioning member and ensure that the inner end of the positioning member extends into the second positioning groove of the fixing column. The limiting position is used for limiting the separation of the first spring from the fixing sleeve and also limiting the movement of the movable member, thereby preventing the movable member from separating from the fixing sleeve under the action of the operation portion of the steering bracket.

Preferably, a positioning bump extending to the inner circumferential side is provided on the inner wall of the movable member, the inner surface of the positioning bump forms the first limiting surface, and the first spring is restricted between the positioning bump and the limiting portion; and, the positioning bump deviates from the end of the movable member, and the part of the movable member deviating from the positioning bump is sleeved outside the first spring.

With this arrangement, the first spring is prevented from directly pressing on the end face of the movable piece, so that the first spring can be made longer to improve the pressing force on the movable member. The end of the first spring is located between the movable member and the fixing sleeve, so that the first spring is protected.

Preferably, the movable member is provided with a second limiting surface used for limiting the separation of the positioning member from the first positioning groove; the second limiting surface is farther from the outer wall of the fixing sleeve than the first limiting surface; the distance between the second limiting surface and the outer wall of the fixing sleeve is less than the length of the positioning member in the axial direction of the first positioning groove; and, the width of the opening of the inner end of the first positioning groove is less than the maximum width of the positioning member.

By providing the second limiting surface, the separation of the positioning member from the fixing sleeve is avoided, and the stability of the transportation tool of the present invention when in use is ensured.

The present invention can realize the quick assembling and disassembling of the steering bracket and the body bracket, and is very convenient to use.

### BRIEF DESCRIPTION OF THE DRAWINGS

FIG. 1 is a schematic structure diagram of the present invention;

FIG. 2 is a schematic structure diagram of the connecting portion, the fixing sleeve and the fixing column of the present invention;

FIG. 3 is a schematic structure diagram of the present invention when the fixing sleeve is separated from the fixing column;

FIG. 4 is a schematic structure diagram of the movable member of the present invention;

FIG. 5 is an enlarged view at the connecting plates and the movable member of the present invention; and

FIG. 6 is a schematic structure diagram at the pull rope and the operation handle of the present invention.

### DETAILED DESCRIPTION OF THE INVENTION

The present invention will be further described below by specific embodiments with reference to the accompanying drawings.

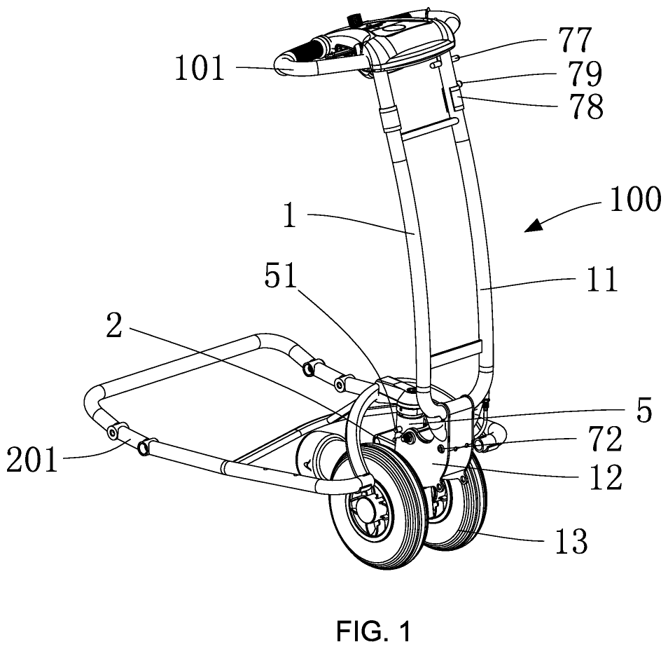

As shown in FIG. 1, the present invention discloses a fixing structure for a steering bracket and a body bracket of a transportation tool. The steering bracket 100 includes an operation portion 1 used for fixing a handlebar 101 and a connecting portion 2 used for fixing front wheels 13. Two front wheels 13 are provided on the lower side of the connecting portion, the operation portion 1 and the connecting portion 2 are rotationally fixed, and a rotating axis is arranged in the left-right direction. The body bracket includes a pedal bracket 201 and a saddle bracket. The pedal bracket 201 is fixed to the connecting portion 2 through a detachable fixing structure, and rear wheels are provided at the rear lower end of the saddle bracket.

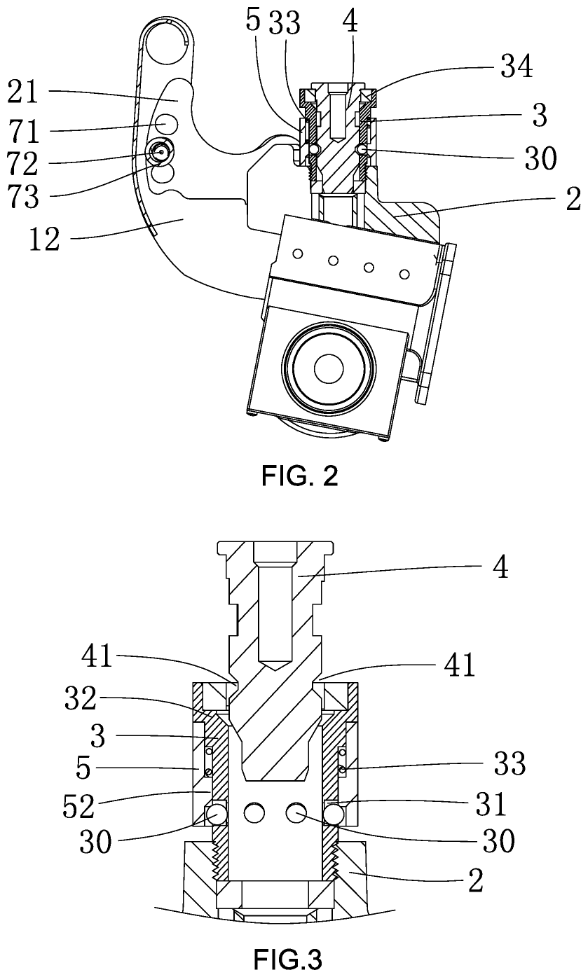

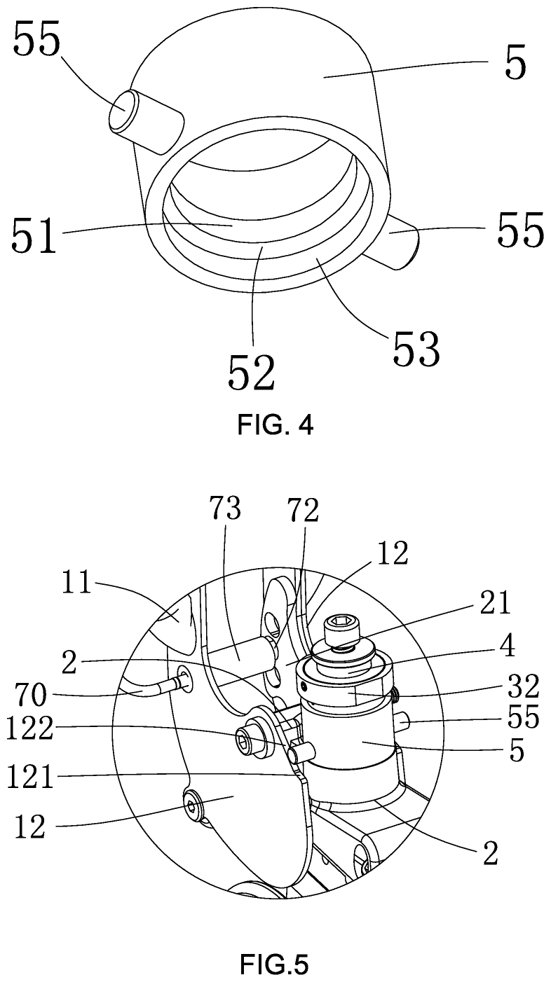

As shown in FIGS. 1-4, the detachable fixing structure includes a fixing sleeve 3 and a fixing column 4 capable of extending into the fixing sleeve 3. The steering bracket 100 can rotate about the axis of the fixing column 4. The fixing sleeve 3 is fixed on the upper side of the connecting portion 2 of the steering bracket, and the fixing column 4 is fixed at the front end of the pedal bracket 201. The lower end of the fixing sleeve 3 is in threaded connection to the connecting portion 2, while the upper end thereof is provided with an opening for allowing the fixing column 4 to extend therein.

A first positioning groove 31 is formed on the inner wall of the fixing sleeve 3 and fits with a positioning member 30, and a second positioning groove 41 is formed on the outer wall of the fixing column 4. A movable member 5 with an annular section is sleeved outside the fixing sleeve 3, and the movable member 5 has a first limiting surface 51 used for coming into contact with the outer end of the positioning member 30 so that the inner end of the positioning member 30 can extend into an inner cavity of the fixing sleeve 3 or into the second positioning groove 41. The first positioning groove 31 runs through the inner and outer walls of the fixing sleeve 3. The movable member 5 is linked with the operation portion 1. When the upper end of the operation portion 1 turns forward, the operation portion 1 pushes the movable member 5 to move upward, so that the first limiting surface 51 moves away from the positioning member 30 and the position limitation of the positioning member 30 is canceled out. The positioning member 30 is a steel boll and is spherical. Bearings 34 are fixed in two ends of the fixing sleeve 3. When the fixing column 4 extends into the fixing sleeve 3, the outer wall of the fixing column 4 is in clearance fit with the inner walls of the inner circles of the bearings 34.

A limiting portion 32 extending to the outer circumferential side is arranged at the upper end of the fixing sleeve 3, and a first spring 33 is arranged outside the fixing sleeve 3. The first spring 33 is restricted between the limiting portion 32 and the movable member 5, and the movable member 5 is restricted between the limiting portion 32 and the fixing portion 2. The movable member 5 has a tendency to move downward under the action of the first spring 33 and pushes the first limiting surface 51 to come into contact with the outer end of the positioning member 30. A positioning bump 52 extending to the inner circumferential side is provided on the inner wall of the movable member 5 that deviates the upper and lower ends, the inner surface of the positioning bump 51 forms the first limiting surface 51, the first spring 33 is restricted between the upper end face of the positioning bump 51 and the lower end face of the limiting portion 32, and the lower end of the first spring 33 is located on the inner side of the movable member 5.

The movable member 5 is provided with a second limiting surface 53 used for limiting the separation of the positioning member 50 from the first positioning groove 31. The second limiting surface 53 is farther from the outer wall of the fixing sleeve 3 than the first limiting surface 51. The distance between the second limiting surface 53 and the outer wall of the fixing sleeve 3 is less than the diameter of the positioning member 30, and the width of the opening of the inner end of the first positioning groove 31 is less than the maximum width of the positioning member 30.

As shown in FIGS. 1, 2 and 5, the operation portion 1 includes a vertical extension portion 11 and connecting plates 12 located at the lower end of the vertical extension portion 11, and middle portions of the connecting plates 12 are rotationally fixed to the connecting portion 2. The connecting plates 12 are arranged on the left and right sides of the lower end of the vertical extension portion 11, and there are totally two connecting plates 12. The fixing sleeve 3 and the movable member 5 are relatively located between the two connecting plates 12, and linkage bumps 55 extending to the outer side are arranged on the left and right sides of the movable member 5. Each of the two connecting plates 12 includes a second contact surface 122 and a first contact surface 121 used for pushing the linkage bumps 55 to move up, the second contact surface 122 gradually extends downward from front to back and is connected to the first contact surface 121, and the first contact surface 121 and the second contact surface 122 form an obtuse angle. When in the normal use of the transportation tool of the present invention, the first contact surfaces 121 are located directly below the linkage bumps 55.

A fixing block 21 is arranged on the front side of the connecting portion 2, the junction of the connecting plates 12 and the connecting portion 2 deviates from the front end of the fixing block 21, and a locking mechanism used for maintaining the position of the operation portion 1 is arranged between the fixing block 21 and the connecting plates 12. The locking mechanism includes positioning holes 71 formed on the fixing block 21 and the connecting plates 12 and a locking pin 72 inserted into the positioning holes 71. The locking pin 72 is slidingly fitted in a sliding sleeve 73. The sliding sleeve 73 is fixed to the connecting plate on the left side of the lower end of the operation portion 1. The positioning holes 71 are formed on the connecting plate on the right side and the fixing block 21. A second spring (not shown) used for allowing the end of the locking pin 72 to extend out of the sliding sleeve 73 is provided in the sliding sleeve 73. The locking pin 72 is fixed to one end of the pull rope 74, while the other end of the pull rope 74 passes through the sliding sleeve 73 and extends into the vertical extension portion 11. A protective tube 70 is provided to protect the part of the pull rope 74 on the outer side of the vertical extension portion.

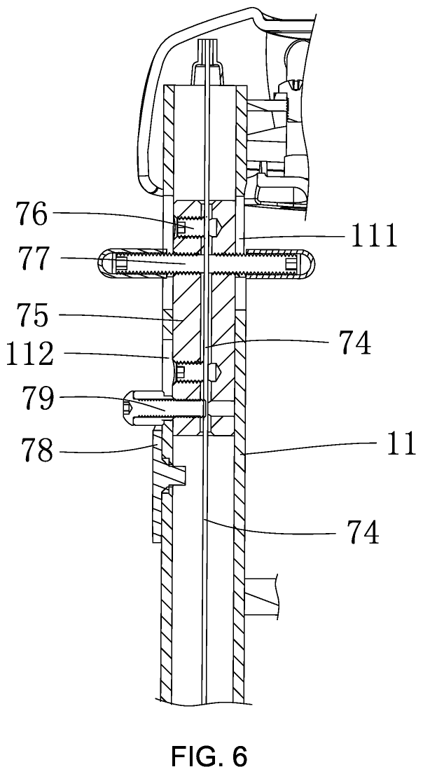

As shown in FIG. 6, an accommodating cavity arranged vertically is provided in the vertical extension portion 11, and a slider 75 is provided in the accommodating cavity. A through hole for allowing the pull rope 74 to pass therethrough is formed on the slider 75, and the upper end of the pull rope 74 extends into the through hole. A fixing screw 76 is in threaded fit on the slider 75, the end of the fixing screw 76 compresses on the pull rope 74, and the slider 75 is fixed to the operation handle 77. A guide groove 111 communicated with the accommodating cavity is formed at the upper end of the vertical extension portion 11, and two ends of the operation handle 77 pass through the guide groove to extend to the outer side of the vertical extension portion 11. A limiting bump 78 used for avoiding excessive downward movement of the pull rope is arranged outside of the vertical extension portion 11, a support bump 79 is arranged on the slider 75, and the limiting bump 78 is always located on the lower side of the support bump 79. An evading groove 112 communicated with the accommodating cavity is formed at the upper end of the vertical extension portion 11. The support bump 79 is pin-shaped; and, one end of the support bump 79 is fixed to the slider 75, while the other end thereof extends outside the vertical extension portion 11 through the evading groove 112. Both the guide groove 111 and the evading groove 112 are arranged in the upper portion of the vertical extension portion 11.

When it is necessary to disassemble the steering bracket and the body bracket, the user stands and presses the operation handle with his/her hand to unlock the locking mechanism; then, the user drives the operation portion of the steering bracket to move forward, and the operation portion of the steering bracket moves relative to the fixing portion of the steering bracket and drives the movable member on the upper side of the fixing portion to move upward so as to release the limitation of the positioning member, so that the positioning member can move outward and the end of the body bracket where the fixing column is fixed is finally lifted up. If it is necessary to assemble the steering bracket and the body bracket, the locking mechanism is unlocked. After the operation portion turns forward to move the movable member upward, the fixing column of the body bracket extends into the fixing sleeve, and then the operation portion is restored. The position of the movable member after raising is maintained by the weight of the operation portion of the steering bracket.

The present invention can realize the quick assembling and disassembling of the steering bracket and the body bracket, and is very convenient to use. Moreover, the structure of the present invention does not affect the normal folding and use of the transportation tool, and the structure is compact.

1. A fixing structure for a steering bracket and a body bracket of a transportation tool, wherein the steering bracket comprises an operation portion used for fixing a handlebar and a connecting portion used for fixing a front wheel; the operation portion and the connecting portion are rotationally fixed, and a rotating axis is arranged in a left-right direction; a detachable fixing structure is arranged between the connecting portion and the body bracket; the detachable fixing structure comprises a fixing sleeve and a fixing column capable of extending into the fixing sleeve; the steering bracket is rotatable about the axis of the fixing column; one of the fixing sleeve and the fixing column is fixed to the steering bracket, while the other one of the fixing sleeve and the fixing column is fixed to the steering bracket; a first positioning groove is formed on an inner wall of the fixing sleeve and fits with a positioning member; a second positioning groove is formed on an outer wall of the fixing column; the fixing sleeve is movably connected to a movable member; the movable member has a first limiting surface used for coming into contact with an outer end of the positioning member so that an inner end of the positioning member can extend into an inner cavity of the fixing sleeve or into the second positioning groove; the movable member is linked with the operation portion; and, when the operation portion rotates, the operation portion drives the movable member to move, so that the first limiting surface moves away from the positioning member and position limitation of the positioning member is canceled out.

2. The fixing structure for a steering bracket and a body bracket of a transportation tool according to claim 1, wherein the movable member is sleeved outside the fixing sleeve and the first positioning groove runs through the inner and outer sides of the fixing sleeve.

3. The fixing structure for a steering bracket and a body bracket of a transportation tool according to claim 1, wherein the operation portion comprises a vertical extension portion and connecting plates located at a lower end of the vertical extension portion; middle portions of the connecting plates are rotationally fixed to the connecting portion; and, when an upper end of the operation portion turns forward, rear portions of the connecting plates move upward and push the movable member to move.

4. The fixing structure for a steering bracket and a body bracket of a transportation tool according to claim 3, wherein the connecting plates are arranged on left and right sides of the lower end of the vertical extension portion; the fixing sleeve and the movable member are relatively located between the two connecting plates; the movable member has linkage bumps extending to the outer side; and, when the upper end of the operation portions turns forward, the rear portions of the connecting portions move upward and come into contact with the linkage bumps.

5. The fixing structure for a steering bracket and a body bracket of a transportation tool according to claim 4, wherein each of the connecting plates comprises a first contact surface used for pushing the linkage bumps to move and a second contact surface capable of coming into contact with the first contact surface; the second contact surface gradually extends upward or downward from front to back and is connected to the first contact surface; and, the first contact surface and the second contact surface form an obtuse angle.

6. The fixing structure for a steering bracket and a body bracket of a transportation tool according to claim 3 or 4, wherein a fixing block is arranged on the front side of the connecting portion; a junction of the connecting plates and the connecting portion deviates from the front end of the fixing block; a locking mechanism used for maintaining the position of the operation portion is arranged between the fixing block and the connecting plates; and, the locking mechanism comprises positioning holes formed on the fixing block and the connecting plates and a locking pin inserted into the positioning holes.

7. The fixing structure for a steering bracket and a body bracket of a transportation tool according to claim 5, wherein the locking pin is slidingly fitted in a sliding sleeve; the sliding sleeve is fixed to the operation portion; a second spring used for allowing the end of the locking pin to extend into the positioning holes is arranged in the sliding sleeve; the locking pin is fixed to one end of a pull rope, while the other ends of the pull rope passes through the sliding sleeve and extends into the vertical extension portion to be linked and connected to an operation handle; an accommodating cavity which extends in its own length direction and is used for accommodating the pull rope is formed in the vertical extension portion; a guide groove communicated with the accommodating cavity is formed at the upper end of the vertical extension portion; the outer end of the operation handle extends to the outer side of the vertical extension portion; a limiting bump used for avoiding excessive downward movement of the pull rope is arranged inside or outside the vertical extension portion; the operation handle is fixed and linked to a support bump; and, the limiting bump is always located on the lower side of the support bump.

8. The fixing structure for a steering bracket and a body bracket of a transportation tool according to claim 1, 2 or 3, wherein a limiting portion extending to the outer circumferential side is arranged at the end of the fixing sleeve where the opening for allowing the fixing column to extend therein is formed; a first spring is arranged outside the fixing sleeve; the first spring is restricted between the limiting portion and the movable member, the movable member is restricted on one side of the limiting portion; and, the movable member has a tendency to move in its own axial direction under the action of the first spring and pushes the first limiting surface to come into contact with the outer end of the positioning member; the first spring is provided to ensure the effective contact between the first limiting surface of the fixing sleeve and the positioning member and ensure that the inner end of the positioning member extends into the second positioning groove of the fixing column.

9. The fixing structure for a steering bracket and a body bracket of a transportation tool according to claim 6, wherein a positioning bump extending to the inner circumferential side is provided on the inner wall of the movable member, the inner surface of the positioning bump forms the first limiting surface, and the first spring is restricted between the positioning bump and the limiting portion; and, the positioning bump deviates from the end of the movable member, and the part of the movable member deviating from the positioning bump is sleeved outside the first spring.

10. The fixing structure for a steering bracket and a body bracket of a transportation tool according to claim 7, wherein the movable member is provided with a second limiting surface used for limiting the separation of the positioning member from the first positioning groove; the second limiting surface is farther from the outer wall of the fixing sleeve than the first limiting surface; a distance between the second limiting surface and the outer wall of the fixing sleeve is less than the length of the positioning member in the axial direction of the first positioning groove; and, the width of the opening of the inner end of the first positioning groove is less than the maximum width of the positioning member.
